(19) United States
(12) Patent Application Publication
(10) Pub. No.: US 2014/0032537 A1
(43) Pub. Date: Jan. 30, 2014

(54) APPARATUS, SYSTEM, AND METHOD FOR MUSIC IDENTIFICATION

(71) Applicant: Ajay Shekhawat, San Francisco, CA (US)

(72) Inventor: Ajay Shekhawat, San Francisco, CA (US)

(21) Appl. No.: 13/562,311

(22) Filed: Jul. 30, 2012

(51) Int. Cl. G06F 17/30

(52) U.S. Cl. 707/723; 707/E17.015

(57) ABSTRACT

Embodiments disclosed herein may relate to identifying music from a text source utilizing a computing platform in a communication system.

### BACKGROUND

1. Field

Subject matter disclosed herein may relate to identifying music from a text source utilizing a computing platform in a communication system.

2. Information

During the viewing of a video object, such as, for example, a television program, a viewer may desire to discover information about some aspects of the video object. Various video playback devices, such as televisions, for example, may be connected to one or more communications networks. With networks such as the Internet and local area networks gaining tremendous popularity, video playback devices may communicate with various server computing platforms, databases and/or search engines, and may facilitate searches initiated by a video playback device and/or system to determine information related to the video object.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram illustrating an example system for identifying a song from a media source in accordance with an embodiment.

FIG. 2 is a schematic block diagram illustrating an example system comprising a plurality of search engines for identifying a song from a media source in accordance with an embodiment.

FIG. 3 is a flow diagram illustrating an example process for identifying a song title in accordance with an embodiment.

FIG. 4 is a block diagram illustrating an example system for identifying a song from a media source in accordance with an embodiment.

FIG. 5 is a block diagram illustrating an example system comprising a plurality of computing devices coupled via a network in accordance with an embodiment.

Reference is made in the following detailed description to the accompanying drawings, which form a part hereof, wherein like numerals may designate like parts throughout to indicate corresponding and/or analogous elements. It will be appreciated that elements illustrated in the figures have not necessarily been drawn to scale, such as for simplicity and/or clarity of illustration. For example, dimensions of some elements may be exaggerated relative to other elements for clarity. Further, it is to be understood that other embodiments may be utilized. Furthermore, structural and/or logical changes may be made without departing from the scope of claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit the scope of claimed subject matter and/or equivalents.

### DETAILED DESCRIPTION

As mentioned above, a viewer may desire to discover information about some aspects of the video object during the viewing of a video object, such as, for example, a television program. Today's wide area networks, such as the Internet, may allow communication between video playback devices and various server computing platforms, peer computing platforms, databases and/or search engines. Such communication between video playback devices, such as televisions, for example, and server computing platforms, peer computing platforms, databases and/or search engines, may facilitate searches initiated by a video playback device and/or system to determine information related to the video object. For example, a user may wish to identify a musical selection of a video object.

In an embodiment, lyrical content related to a video object may be derived from closed caption information of the video object. Also, in an embodiment, lyrical content may be utilized to construct one or more queries that may be submitted to one or more search engines in an effort to identify one or more songs that may include the lyrical content derived from the closed caption information. Identity information for the one or more songs may be delivered to user device, such as, for example, a tablet, in an embodiment. Of course, claimed subject matter is not limited in scope to the particular examples described herein. For example, although embodiments described herein may derive lyrical content from closed captioning text information associated with a video object, other embodiments may derive lyrical content from news report text from one or more websites, and/or from speech recognition systems operating on an audio source, such as an audio track of a video object, to name but a couple of examples.

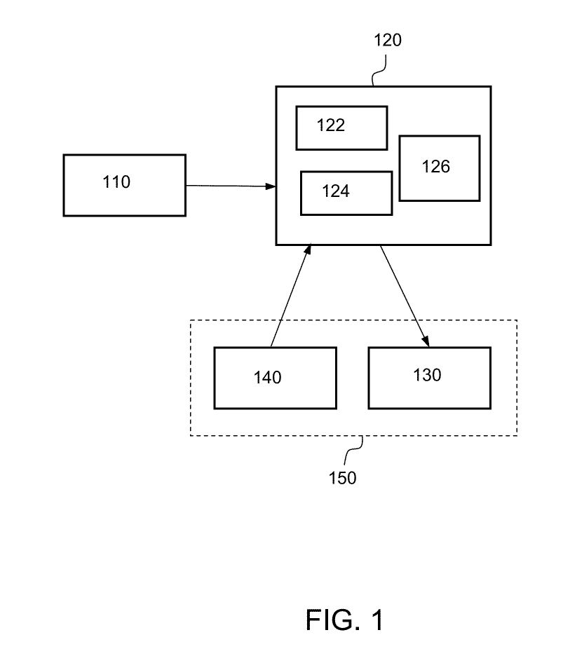

FIG. 1 is a schematic block diagram illustrating an example system for identifying a song from a media source in accordance with an embodiment. In an embodiment, a display module 110 may process a media stream. For example, in an example embodiment, display module 110 may comprise a television coupled to a search engine 120, and may process a media stream comprising television content. In an embodiment, television content may comprise signals received from a satellite television system. In another embodiment, television content may comprise signals received over-the-air from a television signal provider. Other example television content may comprise analog and/or digital television signals received from a cable television provider. Of course, these are merely example sources of television content, and claimed subject matter is not limited in scope in this respect. Additionally, television content is merely an example media type, and claimed subject matter may include other media types. Other example media types may include signals and/or data stored on optical disks, such as digital video discs (DVD) and/or Blu-Ray discs. Still other example media types may include digital and/or analog radio signals, although again, claimed subject matter is not limited in scope in these respects. Audio and/or video content streamed over a network, such as the Internet, may also be utilized in one or more embodiments. For example, video content streamed over the Internet may provide closed captioning information, in an embodiment. Similarly, video content received over a satellite system may comprise closed captioning information, in an embodiment. Additionally, video content received from a cable television provider may further comprise closed captioning information, in an embodiment.

In an embodiment, display module 110 may process a media stream comprising closed captioning information, and display module 110 may detect textual information included with the closed captioning information. For example, in an embodiment, display module 110 may detect text from closed captioning information from television content, and may deliver detected text to search engine 120. In an embodiment, search engine 120 may comprise a query composition module 122, a search module 124, and a results module 126. Query composition module may form one or more queries from text received from display module 110 utilizing a “sliding window” technique. For example, individual sliding windows may comprise a specified range or amount of most recent closed captioning words from which query composition module 122 may form queries to be processed by search module 124. In an embodiment, individual sliding windows may comprise amounts of words ranging from nine to twelve, although claimed subject matter is not limited in scope in this respect. Further, in an embodiment, query composition module 122 may form one or more queries from identified lyrical content and may provide the one or more queries to a search module 124. Search module 122 may utilize the one or more queries to search for one or more songs that may include the lyrical content represented by the one or more queries, in an embodiment.

In another embodiment, detected textual information may comprise explicitly identified lyrical content from one or more songs. For example, display module 110 may detect one or more textual characters that may denote a label “Music” in closed captioning information, wherein “Music” may be displayed to a user to alert the user that displayed text may comprise lyrical content for one or more songs. Display module 110 may utilize the “Music” label to identify text that may comprise lyrical content.

Further, in an embodiment, search module 124 and/or query composition module 122 may append one or more keywords, such as “lyric”, for example, to a query comprising one or more words of text to indicate to search module 124 and that the words of text making up the query are intended to represent lyrical content. An appended keyword such as “lyric” may allow search module 124 to focus search activities on lyrics-oriented sites. In an embodiment, preferred sites that cater to lyrical content may be specified.

Search results, in an embodiment, may be provided to a user display module 130, and one or more identified song titles may be displayed to a user. In this manner, as a video element is processed and/or displayed by display module 110, and search engine 120 may be form queries comprising textual elements purportedly comprising lyrical content. One or more songs may be identified by search engine 120, and in particular by results module 126, in an embodiment, and one or more respective song titles may be displayed to a user by way of user display module 130. A user may thus be provided with titles of songs related to media content playing on display module 110.

In an embodiment, a recognition module 140 may utilize audio fingerprint techniques to detect which video is playing on display module 110, for example. Recognition module 140 may, for example, detect a particular video content being played on display module 110 and may transmit an identity of the video content to search engine 120, in an embodiment. Search engine may, in response to receiving an identity of a video content from recognition module 140, analyze and/or otherwise process close captioning information for the video content being displayed on display module 110 in order to form queries that may be utilized to search one or more web sites for lyrical content in order to determine one or more song titles to transmit to user display module 130.

In an embodiment, recognition module 140 and user display module 130 may comprise a single user device 150, although claimed subject matter is not limited in scope in this respect. For example, user device 150 may comprise a tablet device, for example. A tablet 150, for example, may recognize video content being displayed on display module 110, and may signal a title of the video content to search engine 120. Tablet 150 may further display search results comprising one or more song titles to the user by way of user display module 130. In this manner, the user may be made aware of songs referred to by the video content. Of course, a tablet is merely one example type of user device 150, and claimed subject matter is not limited in scope in this respect.

Although embodiments described herein may incorporate recognition module 140 and user display module 130 within the same user device 150, claimed subject matter is not limited in this respect, and other embodiments are possible where recognition module 140 and user display module 130 are separate components. Additionally, although logic for processing queries for search engine 120 and logic for processing search results to identify song titles and/or artist names may be depicted as being incorporated into a single device, such as search engine 120 which may comprise a server computing platform, for example, other embodiments may implement query composition module 122 and/or results module 126 at other devices. For example, query composition module 122 may be implemented in user device 150 and/or may be implemented in display module 110, for one or more embodiments.

In various example embodiments, display module 110 may comprise a satellite television receiver, television, set-top box, cable television receiver, cellular telephone, tablet device, wireless communication device, user equipment, desktop computer, game console, laptop computer, other personal communication system (PCS) device, personal digital assistant (PDA), personal audio device (PAD), portable navigational device, or other portable communication device. Display module 110 may also comprise a processor or computing platform adapted to perform functions controlled by machine-readable instructions, for example. Also, in an embodiment, search engine 120 may comprise a server computing platform, although claimed subject matter is not limited in scope in this respect.

Additionally, in various embodiments, recognition module 140, user display module 130, and/or a user device 150 may comprise a cellular telephone, tablet device, wireless communication device, user equipment, desktop computer, game console, laptop computer, other personal communication system (PCS) device, personal digital assistant (PDA), personal audio device (PAD), portable navigational device, or other portable communication devices. A user device and/or user display device may also comprise a processor or computing platform adapted to perform functions controlled by machine-readable instructions, for example.

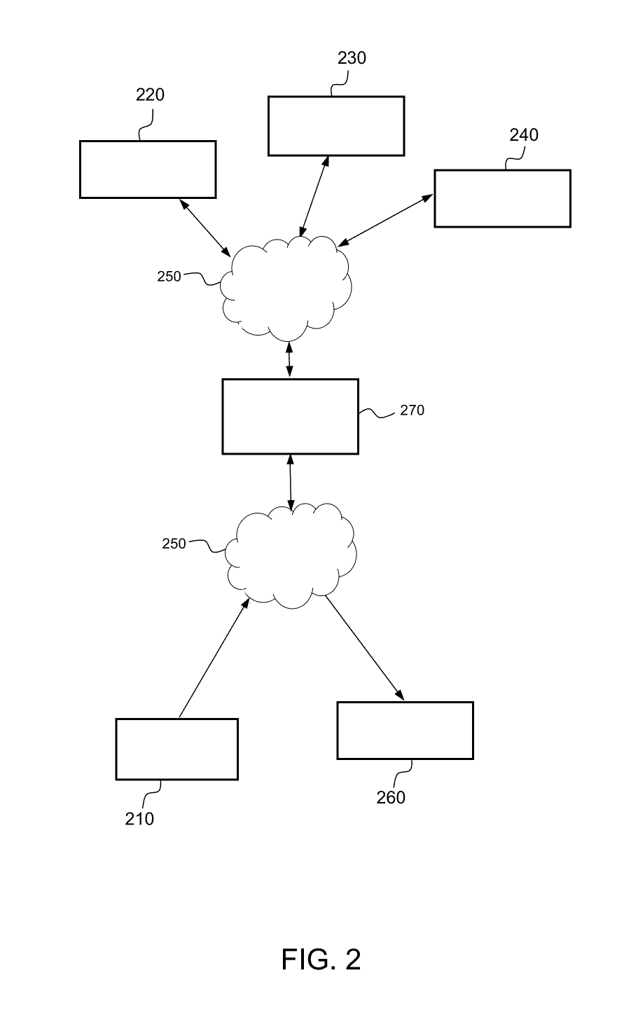

FIG. 2 is a schematic block diagram illustrating an example system for identifying a song from a media source in accordance with an embodiment. Further, in an embodiment, multiple search engines may be utilized and/or multiple search results may be aggregated into a composite result set. For example, a media player 210 may glean one or more words of text from a media source, such as, for example, closed captioning information from a television signal. One or more queries may be formed utilizing, at least in part, the one or more words of text from the closed captioning information, and the queries may be transmitted by media player 210 to one or more search engines 270 via communications network 250. In an embodiment, media player 210 may comprise query composition logic and may also comprise a recognition module, although claimed subject matter is not limited in scope in these respects. Search engine 270 may search web sites 220, 230, and/or 240, for example, via a communications network 250, in an embodiment. Also, in an embodiment, web sites 220, 230, and 240 may comprise web pages that contain lyrical content. Further, in an embodiment, one or more search results may be provided by search engines 220, 230, and/or 240 to a user device 260 for presentation to a user. In an embodiment, communications network 250 may comprise a cellular communications network, although claimed subject matter is not limited in scope in this respect. Other embodiments may comprise packet-based networks, for example, although again, claimed subject matter is not limited in scope in this respect. Various example network types are provided below.

Additionally, in one or more embodiments, search results may be ranked and/or scored. Also, in an embodiment, search results may be analyzed and a single result may be selected to present to a user. Claimed subject matter may comprise any techniques available now or in the future for analyzing and/or ranking search results. For example, search result analysis may comprise determining which of a set of multiple potential song matches is the most popular based at least in part on a frequency of appearance of a particular song in previous queries submitted by one or more users and/or by one or more media players. Search result analysis may also take into account amounts of radio play and/or sales information for various candidate songs to determine a most appropriate search result to present to a user. In an embodiment, search result analysis may be performed, at least in part, at user device 260, although claimed subject matter is not limited in this respect.

As mentioned above, in one or more embodiments for identifying a song from a media source, one or more search engines may individually generate one or more search results in response to receiving one or more queries from a media player, for example. As also mentioned above, individual search engines may return results from particular web sites known to specifically cater to song lyrics, for example. Individual search engines may or may not perform additional filtering on search results, as mentioned above. In an embodiment, example techniques for extracting song title information from search results from one or more search engines may be performed prior to delivering song title information to a user, as described more fully below.

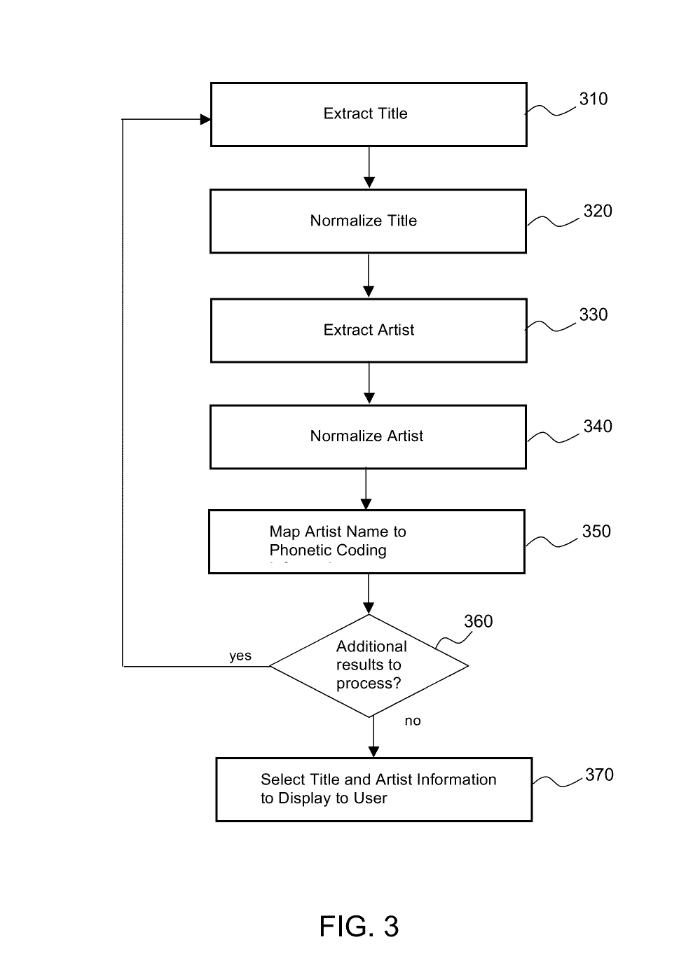

FIG. 3 is a flow diagram of an example process for extracting song title information from one or more search results from one or more search engines, in an embodiment. In an embodiment, song title and artist name information provided by the one or more web sites and/or one or more search engines may be normalized so that song title and artist name information may be uniformly represented. For example, in an embodiment, various web sites may utilize different techniques for representing song title and artist name information. Therefore, in an embodiment, site-specific techniques for extracting song title and artist name information may be utilized for search results returned from various web sites. For example, one web site may represent a song title and artist name as “Hey Jude by the Beatles”. Another web site may represent the same information as “Beatles—Hey Jude”, for example. An additional web site may represent the identical information as “Hey Jude (Beatles)”, for another example.

For the example process illustrated in FIG. 3, individual search results from one or more web sites and/or one or more search engines may be processed until no search results remain. For example, a song title for an individual search result may be extracted at block 310. At block 320, the song title for the individual search result may be normalized. For example, in an embodiment, a song title may be normalized at least in part by converting text into lower case and/or by dropping punctuation, although claimed subject matter is not limited in scope in these respects. Example normalization techniques for song titles may also include dropping white space and/or dropping content after a specified punctuation character a “(”, in an embodiment. Also, in an embodiment, a normalized version of a song title may stored in a memory of a computing platform, for example. Also, in an embodiment, an original version of a song title may be stored in the memory of the computing platform, wherein the normalized version of the song title may be associated with the original version by way of a mapping process, for example.

At block 330, artist name information for the song of a current search result may be extracted from the search results. Additionally, at block 340, a normalized version of the artist name information may be generated. Techniques for normalization such as those discussed above for normalizing a song title may also be utilized to normalize artist name information, in an embodiment. Further, a phonetic coding of the artist name may be performed, and an artist's name may be mapped to the phonetic coding, as indicated at block 350, in an embodiment. For example, in an embodiment, a “Soundex” phonetic coding algorithm may be performed, although claimed subject matter is not limited in scope in this respect. Other embodiments in accordance with claimed subject matter may utilize any of a wide range of phonetic coding algorithms. Phonetic coding of artist names may be desirable because at least some artists may either utilize phonetic names and/or may have more than one spelling or representation of a name.

As indicated at block 360, if additional search results remain, processing may return to block 310. If no additional search results remain to be processed, processing may proceed to block 370 wherein a title and artist information to be displayed to a user may be selected, as described more fully below. Embodiments in accordance with claimed subject matter may include all, less than, or more than blocks 310-370. Further, the order of blocks 310-370 is merely an example order, and claimed subject matter is not limited in this respect.

To select an individual song title and artist name to display to a user, any of a wide range of techniques for ranking and selecting search results may be utilized. In an embodiment, results from a search engine may have a score associated with the results. For example, in an embodiment, the higher the score for a particular search result, the more potentially relevant the result. Also, for embodiments that do not score search results, a weighting system may be utilized whereby an appropriate weighting number may be attributed to individual search results. In an embodiment, a weighting number may be assigned in accordance with a confidence value for a particular search result, for example.

In order to select a particular song title and artist name to display to a user, the search results may be accumulated utilizing the ranking information and/or the weighting information. Additionally, in an embodiment, in the absence of rank and/or weight information, a counting technique may be utilized. In an embodiment, a Borda counting technique may be utilized, although claimed subject matter is not limited in scope in these respects. Regardless of the particular technique utilized, individual unique versions of a song title may have its score accumulated. As a result of performing the accumulation operation, one or more song titles may be individually associated with an aggregate score. That is, individually unique song titles may be assigned an individual aggregate score as a result of the accumulation process.

At least in part in response to performing the accumulation operation, aggregate scores for the individual song titles may be analyzed and a song title may be selected for display to a user. In performing such an analysis to select a song title, a determination may be made as to whether an obvious result exists. For example, a particular song title may have an aggregate score that is much greater than scores for other candidate song titles. If such a clear result exists, that particular song title may be selected for display to the user. For a situation where no such clear result exists, other techniques may be utilized to select a song title to display to the user.

For example, in an embodiment, at least in part in response to a difference between accumulated scores of a top-ranked song title and a next-ranked song title exceeding a specified threshold, the top-ranked song title and artist pair may be selected. Also, for an example embodiment, at least in part in response to the top ‘N’ results all comprising an identical song title, the first listed song title may be selected, in an embodiment. In an embodiment, the variable ‘N’ may be specified to be the number 6, for example. This example technique may be advantageous in situations where one search result per web site is provided, for example.

In an embodiment, at least in part in response to a song title having been selected for display to a user, an artist associated with the song title may be selected, as described below. However, in an embodiment, at least in part in response to a failure to select a song title and artist pair for a particular query, a failure condition may be signaled. In an embodiment, a failure to select a song title may simply result in no song title being displayed to the user for a particular query comprising particular closed captioning text.

At least in part in response to a song title being selected for display to a user, an artist for the song title may be selected. In an embodiment, ranking and/or weighting scores of all artists associated with a selected song title may be aggregated according to their normalized versions. Because a song may have been covered by multiple artists, it may be advantageous to select all artists that are strong candidates. Therefore, in an embodiment, selection techniques may be more lenient than those for selecting a song title, because situations may arise wherein several artists may be strongly associated with a particular song title.

In an embodiment, an artist may be considered to be the primary artist at least in part in response to achieving the greatest aggregate score. In an embodiment, all artists associated with a selected song title may be selected for display to the user. However, it may be advantageous to limit the display of artists associated with a selected song to a few number of artists. Example techniques that may be utilized to whittle down the amount of artists to display may include selecting the highest scoring artist after aggregation, selecting any artist that occurs in at least ‘M’ results, wherein ‘M’ may be specified, and/or selecting a highest scoring remaining artist until a sum of the scores of the selected artist exceeds a specified fraction of a total score for a selected song title. Of course, these are merely example techniques for selecting one or more artists to display to a user along with a song title, and the scope of claimed subject matter is not limited in these respects.

At least in part in response to a song title and one or more artists being selected, the song title and artist(s) may be displayed to a user. As mentioned previously, a user may view a display of the song title and artist by way of a tablet device, for example, or by way of a cellular telephone, for another example. In an additional embodiment, one or more hyperlinks may be provided to a user that may allow the user to connect to one or more online music services to purchase, download, and/or play the selected song.

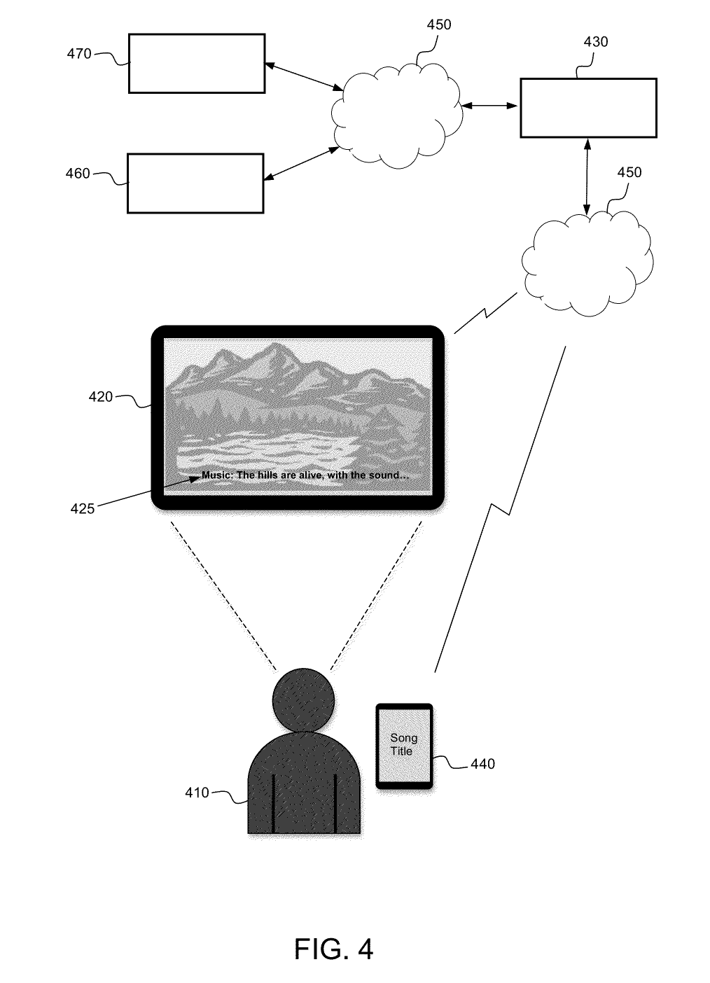

FIG. 4 is a block diagram illustrating an example system for identifying a song from a media source in accordance with an embodiment. The example system of FIG. 4 may comprise a television 420, for example, and a user tablet device 440. A user, such as user 410, may watch television programming on television 420. In an example embodiment, television 420 may detect closed captioning text information 425 from a television signal, for example, and may form one or more queries from one or more words gleaned from the closed captioning text. The one or more queries formed from closed captioning text words may be provided to one or more search engines 430 by way of communications network 450. Search engine 430 may communication with web sites 460 and 470, for example. In an embodiment, web sites 460 and 470 may host web pages containing lyrical content for songs, for example. Also, in an embodiment, communications network 450 may comprise, at least in part, a wireless communication network, for example, although claimed subject matter is not limited in scope in this respect.

In an embodiment, one or more search results may be provided to user 410 by way of user tablet device 440, for example. One or more song titles and/or one or more artist names may be displayed by tablet device 440 to user 410, for example. In this manner, a user 410 may watch television programming on television 420, and may automatically receive information related to songs associated with the television programming. For example, if a song is playing on a jukebox in a scene of a movie being viewed on television 420, information related to the song may be provided to the user by way of the user's tablet device 440.

Information related to a song that may be provided to a user in accordance with claimed subject matter may include, but is not limited to, song title, artist, album name, date of publication

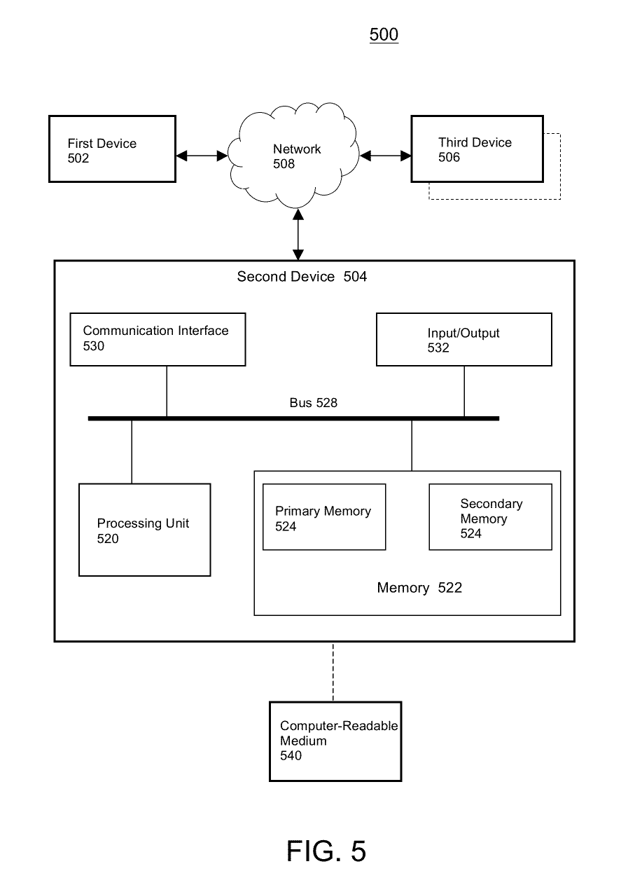

FIG. 5 is a schematic diagram illustrating an exemplary embodiment 500 of a computing environment system that may include one or more devices configurable to implement techniques and/or processes described above related to identifying song titles and artist names from queries gleaned from text information as discussed above in connection with FIGS. 1-4, for example. System 500 may include, for example, a first device 502, a second device 504, and a third device 506, which may be operatively coupled together through a network 508.

First device 502, second device 504 and third device 506, as shown in FIG. 5, may be representative of any device, appliance or machine that may be configurable to exchange data over network 508. By way of example but not limitation, any of first device 502, second device 504, or third device 506 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between at least two of first device 502, second device 504, and third device 506. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 506, there may be additional like devices operatively coupled to network 508.

It is recognized that all or part of the various devices and networks shown in system 500, and the processes and methods as further described herein, may be implemented using or otherwise include hardware, firmware, software, or any combination thereof (other than software per se).

Thus, by way of example but not limitation, second device 504 may include at least one processing unit 520 that is operatively coupled to a memory 522 through a bus 528.

Processing unit 520 may be representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 may be representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 540. Computer-readable medium 540 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

Second device 504 may include, for example, an input/output 532. Input/output 532 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 532 may include an operatively configured display, speaker, keyboard, mouse, trackball, touch screen, data port, etc.

The term “computing platform” as used herein refers to a system and/or a device that includes the ability to process and/or store data in the form of signals or states. Thus, a computing platform, in this context, may comprise hardware, software, firmware or any combination thereof (other than software per se). Computing platform 500, as depicted in FIG. 5, is merely one such example, and the scope of claimed subject matter is not limited in these respects. For one or more embodiments, a computing platform may comprise any of a wide range of digital electronic devices, including, but not limited to, personal desktop or notebook computers, high-definition televisions, digital versatile disc (DVD) players or recorders, game consoles, satellite television receivers, cellular telephones, personal digital assistants, tablet devices, mobile audio or video playback or recording devices, or any combination of the above. Further, unless specifically stated otherwise, a process as described herein, with reference to flow diagrams or otherwise, may also be executed and/or controlled, in whole or in part, by a computing platform.

Wireless communication techniques described herein may be in connection with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN. Further, wireless communications described herein may comprise wireless communications performed in compliance with a 4G wireless communication protocol.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Methodologies described herein may be implemented by various techniques depending, at least in part, on applications according to particular features or examples. For example, methodologies may be implemented in hardware, firmware, or combinations thereof, along with software (other than software per se). In a hardware embodiment, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter.

Some portions of the preceding detailed description have been presented in terms of logic, algorithms and/or symbolic representations of operations on binary states stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and is generally, considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, or the like may refer to actions and/or processes of a specific apparatus, such as a special purpose computer or a similar special purpose electronic computing device. In the context of this specification, therefore, a special purpose computer and/or a similar special purpose electronic computing device is capable of manipulating and/or transforming signals, typically represented as physical electronic and/or magnetic quantities within memories, registers, and/or other information storage devices, transmission devices, or display devices of the special purpose computer and/or similar special purpose electronic computing device. In the context of this particular patent application, the term “specific apparatus” may include a general purpose computer once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change and/or transformation in magnetic orientation or a physical change and/or transformation in molecular structure, such as from crystalline to amorphous or vice-versa. In still other memory devices, a change in physical state may involve quantum mechanical phenomena, such as, superposition, entanglement, or the like, which may involve quantum bits (qubits), for example. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A computer-readable (storage) medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While there has been illustrated and/or described what are presently considered to be example features, it will be understood by those skilled in the art that various other modifications may be made, and/or equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and/or equivalents thereof.

1. A method, comprising:
receiving one or more signals indicative of a query from a user computing platform at a server computing platform, wherein the query comprises one or more textual elements related to video content being displayed to a user;
searching one or more web sites to identify one or more candidate song titles based at least in part on the one or more textual elements of the query;
ranking the one or more candidate song titles from the one or more web sites; and
selecting a song title from the one or more candidate song titles for display to the user.

2. The method of claim 1, further comprising transmitting one or more signals indicative of the selected song title to a user device.

3. The method of claim 1, wherein the video content comprises closed captioning information.

4. The method of claim 3, wherein the one or more textual elements related to the video content being displayed to the user comprises one or more words derived from the closed captioning information.

5. The method of claim 1, wherein said searching the one or more web sites to identify the one or more candidate song titles comprises searching one or more web pages comprising lyrical content for one or more songs.

6. The method of claim 1, further comprising searching the one or more web sites to identify one or more artist names associated with the one or more candidate song titles.

7. The method of claim 6, further comprising ranking the one or more candidate artist names associated with the one or more candidate song titles.

8. The method of claim 7, further comprising selecting an artist name from the one or more candidate artist names for display to the user.

9. An article, comprising: a non-transitory computer-readable medium having stored thereon instructions executable by a computing platform to:
receive one or more signals indicative of a query from a user computing platform, wherein the query comprises one or more textual elements related to video content being displayed to a user;
search one or more web sites to identify one or more candidate song titles based at least in part on the one or more textual elements of the query;
rank the one or more candidate song titles from the one or more web sites; and
select a song title from the one or more candidate song titles for display to the user.

10. The article of claim 9, wherein the computer-readable medium has stored thereon further instructions executable by the computing platform to transmit one or more signals indicative of the selected song title to a user device.

11. The article of claim 9, wherein the video content comprises closed captioning information.

12. The article of claim 11, wherein the one or more textual elements related to the video content being displayed to the user comprises one or more words derived from the closed captioning information.

13. The article of claim 9, wherein the computer-readable medium has stored thereon further instructions executable by the computing platform to search the one or more web sites to identify the one or more candidate song titles at least in part by searching one or more web pages comprising lyrical content for one or more songs.

14. The article of claim 9, wherein the computer-readable medium has stored thereon further instructions executable by the computing platform to search the one or more web sites to identify one or more artist names associated with the one or more candidate song titles.

15. The article of claim 14, wherein the computer-readable medium has stored thereon further instructions executable by the computing platform to rank the one or more candidate artist names associated with the one or more candidate song titles.

16. The article of claim 15, wherein the computer-readable medium has stored thereon further instructions executable by the computing platform to select an artist name from the one or more candidate artist names for display to the user.

17. An apparatus, comprising:
an communications interface to receive one or more signals indicative of a query from a user computing platform, wherein the query comprises one or more textual elements related to video content being displayed to a user;
a processor to search one or more web sites to identify one or more candidate song titles based at least in part on the one or more textual elements of the query, the processor further to rank the one or more candidate song titles from the one or more web sites and to select a song title from the one or more candidate song titles for display to the user.

18. The apparatus of claim 17, the communications interface to transmit one or more signals indicative of the selected song title to a user device.

19. The apparatus of claim 17, wherein the video content comprises closed captioning information.

20. The apparatus of claim 19, wherein the one or more textual elements related to the video content being displayed to the user comprises one or more words derived from the closed captioning information.

21. The apparatus of claim 17, the processor further to search the one or more web sites to identify the one or more candidate song titles at least in part by searching one or more web pages comprising lyrical content for one or more songs.

22. The apparatus of claim 17, the processor further to search the one or more web sites to identify one or more artist names associated with the one or more candidate song titles.

23. The apparatus of claim 22, the processor to rank the one or more candidate artist names associated with the one or more candidate song titles.

24. The apparatus of claim 23, the processor to select an artist name from the one or more candidate artist names for display to the user.

25. An apparatus, comprising:
means for receiving one or more signals indicative of a query from a user computing platform, wherein the query comprises one or more textual elements related to video content being displayed to a user;
means for searching one or more web sites to identify one or more candidate song titles based at least in part on the one or more textual elements of the query;
means for ranking the one or more candidate song titles from the one or more web sites; and
means for selecting a song title from the one or more candidate song titles for display to the user.

26. The apparatus of claim 25, further comprising means for transmitting one or more signals indicative of the selected song title to a user device.

27. The apparatus of claim 25, wherein the video content comprises closed captioning information.

28. The means of claim 27, wherein the one or more textual elements related to the video content being displayed to the user comprises one or more words derived from the closed captioning information.

29. The means of claim 25, wherein said means for searching the one or more web sites to identify the one or more candidate song titles comprises means for searching one or more web pages comprising lyrical content for one or more songs.

30. The means of claim 25, further comprising means for searching the one or more web sites to identify one or more artist names associated with the one or more candidate song titles.

31. The means of claim 30, further comprising means for ranking the one or more candidate artist names associated with the one or more candidate song titles.

32. The means of claim 31, further comprising means for selecting an artist name from the one or more candidate artist names for display to the user.
